(19) United States
(12) Patent Application Publication
(10) Pub. No.: US 2012/0322598 A1
(43) Pub. Date: Dec. 20, 2012

(54) Ratchet Structure of a freewheel and a hub

(76) Inventor: Chang Hui LIN, Hsiu Shui (TW)

(21) Appl. No.: 13/163,162

(22) Filed: Jun. 17, 2011

(51) Int. Cl. F16H 55/30

(52) U.S. Cl. 474/160

(57) ABSTRACT

A structure of a freewheel and a hub contains a hub including a first ratchet having a pair of first teeth, a central shaft, a screw section, and a freewheel set; the hub including a first chainwheel disc assembly, a second chainwheel disc assembly, a plurality of chainwheel disks, and a screw; each chainwheel disc including a through hole, a first groove, and a second groove, a first single sprocket; the first chainwheel disc assembly includes an aperture, a recessed rim, a recess, a pair of notches, and a first double sprocket; wherein the second chainwheel disc assembly includes an opening, a second single sprocket, a raised fringe, a second ratchet and a pair of tooth, both of which are arranged on a front side of the raised fringe.

### BACKGROUND OF THE INVENTION

1. Field of the Invention

The present invention relates to a structure of a freewheel and a hub that when a chain of a bicycle is actuated, a band angle will not generate among the chainwheel disks, the first chainwheel disc assembly, and the second chainwheel disc assembly, thus changing a speed of the freewheel set smoothly.

2. Description of the Prior Art

A conventional structure of a hub and a ratchet includes a plurality of chainwheel disks piled together, and between each two chainwheel disks is defined a pad so as to space the two chainwheel disks apart from each other, the chainwheel disk is connected with the ratchet of the hub, such that a freewheel set rotates to actuate the ratchet and the hub, hence a bicycle is actuated.

However, when a single chainwheel disk of the freewheel set is connected with the ratchet, a first ratchet and notches of the single chainwheel disk have to contact with a second ratchet and first teeth, having a time consuming production. In addition, as the single chainwheel disk is fixed on the ratchet, a contacting area of the groove and ratchet is small, causing a band angle to change a speed of the freewheel set unstably.

The present invention has arisen to mitigate and/or obviate the afore-described disadvantages.

### SUMMARY OF THE INVENTION

The primary object of the present invention is to provide a structure of a freewheel and a hub that is capable of being simplified to lower production time and securing the freewheel assembly.

Another object of the present invention is to provide a structure of a freewheel and a hub that when a chain of a bicycle is actuated, a band angle will not generate among the chainwheel disks, the first chainwheel disc assembly, and the second chainwheel disc assembly, thus changing a speed of the freewheel set smoothly.

To obtain the above objectives, a structure of a freewheel and a hub provided by the present invention contains:

a hub including a first ratchet having a pair of first teeth, a central shaft, a screw section, and a freewheel set;

the hub including a first chainwheel disc assembly, a second chainwheel disc assembly, a plurality of chainwheel disks, and a screw;

each chainwheel disc including a through hole, a first groove, and a second groove, a first single sprocket disposed on an outer periphery thereof;

the first chainwheel disc assembly includes an aperture fixed on a central position thereof, a recessed rim formed on an inner side thereof, a recess arranged on a rear side of the recessed rim, a pair of notches, and a first double sprocket secured on an outer side thereof;

wherein the second chainwheel disc assembly includes an opening disposed on a central position thereof, a second single sprocket fixed on an outer side thereof, a raised fringe formed on a front side of the second single sprocket, a second ratchet and a pair of tooth, both of which are arranged on a front side of the raised fringe.

### BRIEF DESCRIPTION OF THE DRAWINGS

FIG. 1 is a perspective view showing the exploded components of a structure of a freewheel and a hub according to a preferred embodiment of the present invention;

FIG. 2 is another perspective view showing the exploded components of the structure of the freewheel and the hub according to the preferred embodiment of the present invention;

FIG. 3 is a perspective view showing the assembly of the structure of the freewheel and the hub according to the preferred embodiment of the present invention;

FIG. 4 is a cross sectional view showing the exploded components of the structure of the freewheel and the hub according to the preferred embodiment of the present invention;

FIG. 5 is a cross sectional view showing the assembly of the structure of the freewheel and the hub according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

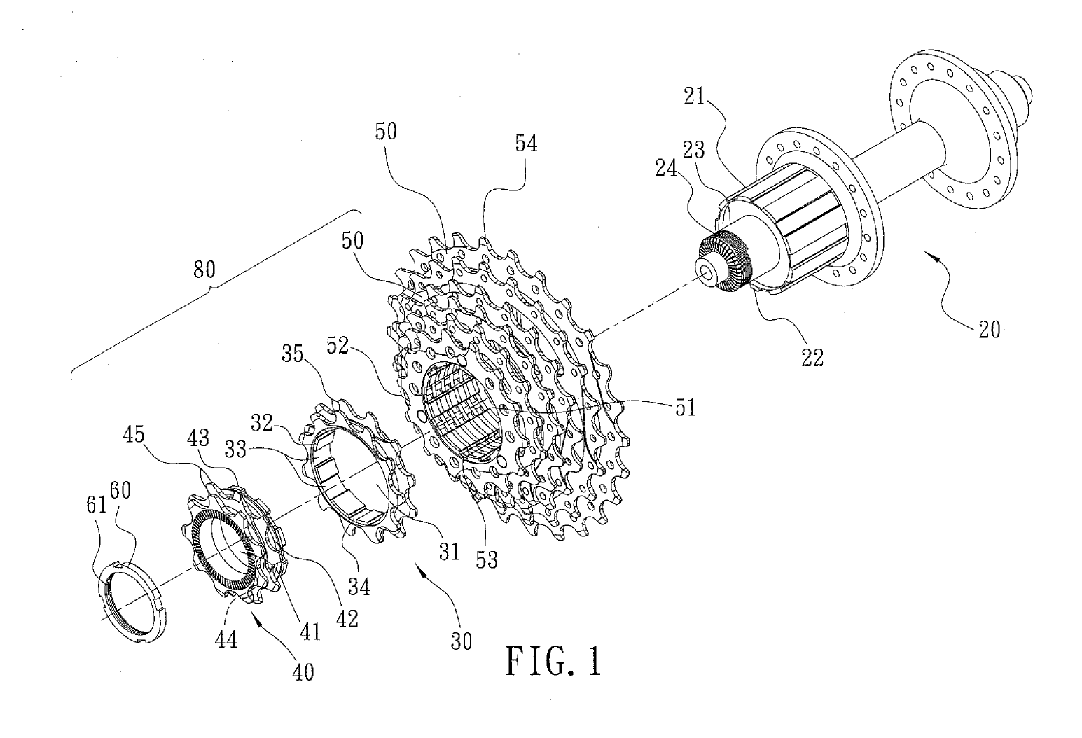

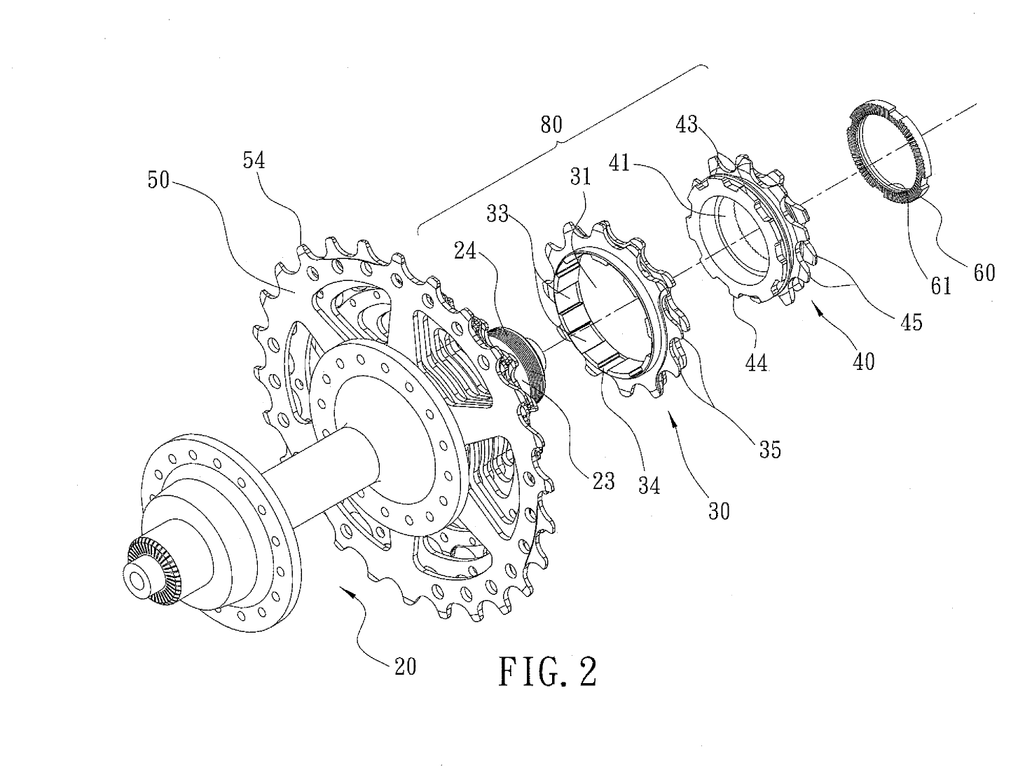

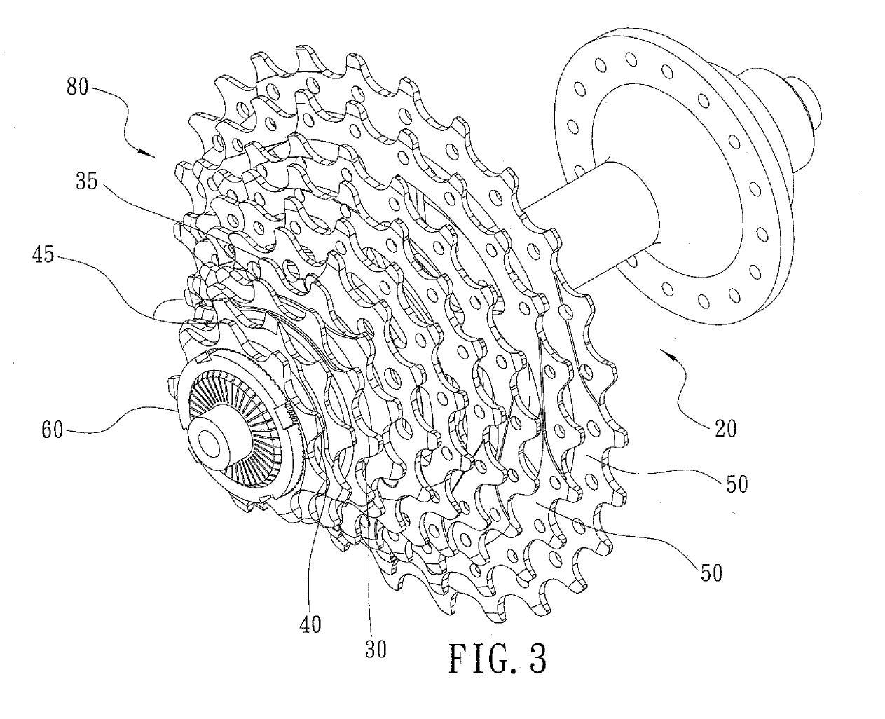

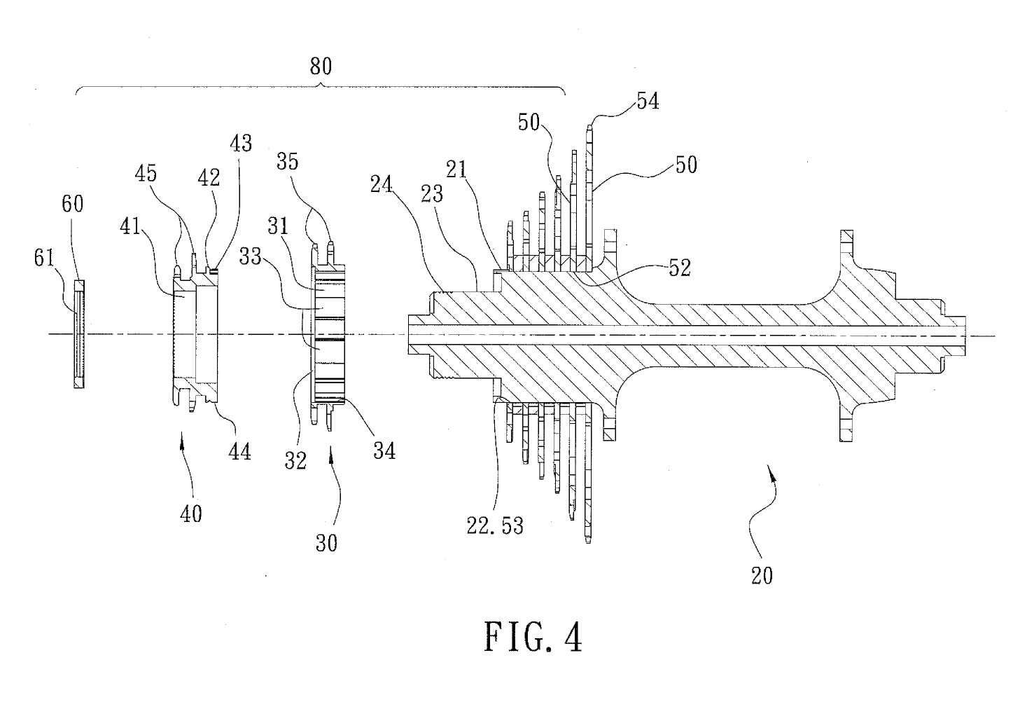

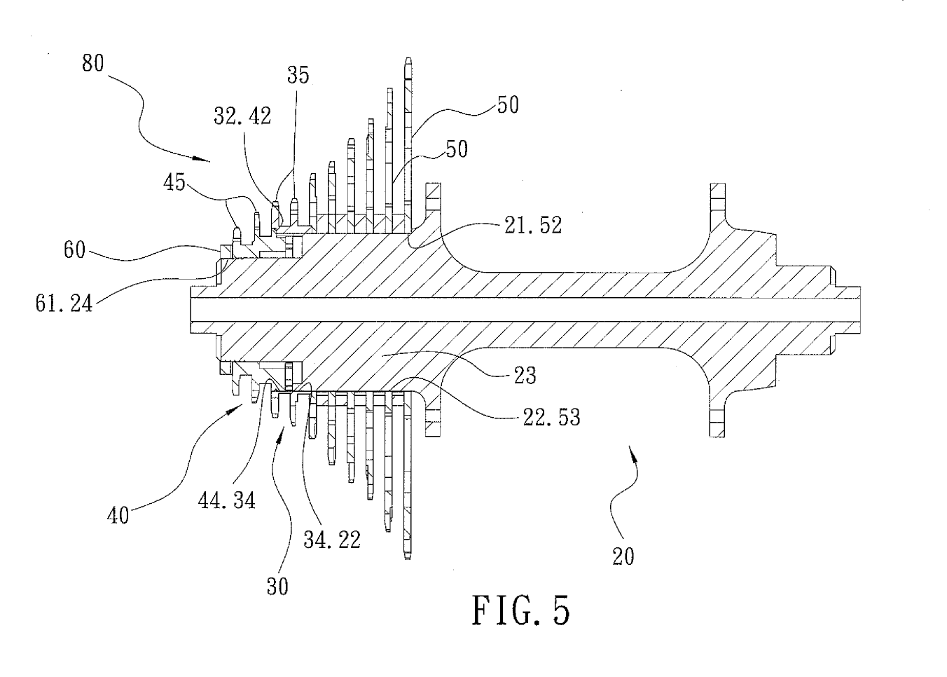

Referring to FIGS. 1-5, a structure of a freewheel and a hub in accordance with a preferred embodiment of the present invention comprises:

a hub 20 including a first ratchet 21 having a pair of first teeth 22, a central shaft 23, a screw section 24, and a freewheel set 80;

the hub 20 including a first chainwheel disc assembly 30, a second chainwheel disc assembly 40, a plurality of chainwheel disks 50, and a screw 60;

each chainwheel disc 50 including a through hole 51, a first groove 52, and a second groove 53, a first single sprocket 54 disposed on an outer periphery thereof;

the first chainwheel disc assembly 30 includes an aperture 31 fixed on a central position thereof, a recessed rim 32 formed on an inner side thereof, a recess 33 arranged on a rear side of the recessed rim 32, a pair of notches 34, and a first double sprocket 35 secured on an outer side thereof.

In assembly, the recess 33 is retained in the first groove 52, and the notches 34 are retained with the second groove 53, hence the recess 33 contacts with the first ratchet 21 so that the first ratchet 21 is fixed securely.

The second chainwheel disc assembly 40 includes an opening 41 disposed on a central position thereof, a second single sprocket 45 fixed on an outer side thereof, a raised fringe 42 formed on a front side of the second single sprocket 45, a second ratchet 43 and a pair of tooth 44, both of which are arranged on a front side of the raised fringe 42. In assembly, the raised fringe 42 is retained with the recessed rim 32, the second ratchet 43 and the tooth 44 are retained in the recess 33 and the notches 34 of the first chainwheel disc assembly 30 respectively, the screw 60 includes threads 61 to screw with the screw section 24 so that the freewheel set 80 is retained tightly.

Thereby, when a chain of a bicycle is actuated, a band angle will not generate among the chainwheel disks 50, the first chainwheel disc assembly 30, and the second chainwheel disc assembly 40, thus changing a speed of the freewheel set smoothly.

While we have shown and described various embodiments in accordance with the present invention, it is clear to those skilled in the art that further embodiments may be made without departing from the scope of the present invention.

What is claimed is:

1. A structure of a freewheel and a hub comprising:
a hub including a first ratchet having a pair of first teeth, a central shaft, a screw section, and a freewheel set;
the hub including a first chainwheel disc assembly, a second chainwheel disc assembly, a plurality of chainwheel disks, and a screw;
each chainwheel disc including a through hole, a first groove, and a second groove, a first single sprocket disposed on an outer periphery thereof;
the first chainwheel disc assembly includes an aperture fixed on a central position thereof, a recessed rim formed on an inner side thereof, a recess arranged on a rear side of the recessed rim, a pair of notches, and a first double sprocket secured on an outer side thereof;
wherein the second chainwheel disc assembly includes an opening disposed on a central position thereof, a second single sprocket fixed on an outer side thereof, a raised fringe formed on a front side of the second single sprocket, a second ratchet and a pair of tooth, both of which are arranged on a front side of the raised fringe.
